(19) United States
(12) Patent Application Publication
(10) Pub. No.: US 2026/0311318 A1
(43) Pub. Date: Oct. 8, 2026

(54) QUALITY ESTIMATION METHOD AND QUALITY ESTIMATION DEVICE

(71) Applicant: Hitachi, Ltd., Tokyo (JP)

(72) Inventors: Toru KOUNO, Tokyo (JP); Jun TSUNODA, Tokyo (JP)

(21) Appl. No.: 19/534,051

(22) Filed: Feb. 9, 2026

(30) Foreign Application Priority Data
Apr. 2, 2025 (JP) 2025-060961

(51) Int. Cl. G06T 7/00; G06V 10/26; G06V 10/32; G06V 10/60

(52) U.S. Cl. CPC G06T 7/0004; G06V 10/26; G06V 10/32; G06V 10/60; G06T 2207/30141

(57) ABSTRACT

In a quality estimation method according to an aspect of the present invention, a relationship between luminance of an EL image and quality of a solar cell module is learned in advance by a learning device, quality classification of the solar cell module is acquired from an output layer of the learning device, and detailed classification of the quality of the solar cell module is acquired from an intermediate layer of the learning device.

### CLAIM OF PRIORITY

The present application claims priority from Japanese patent application No. 2025-060961 filed on Apr. 2, 2025, the content of which is hereby incorporated by reference into this application.

### BACKGROUND OF THE INVENTION

### 1. Field of the Invention

The present invention relates to a technique for estimating quality of a solar cell module.

### 2. Description of the Related Art

Performance of solar cell modules is generally measured by acquiring IV characteristics (a relationship between a cell current and a cell voltage). However, when the performance is measured at a site where the solar cell module is installed, it is troublesome to measure the solar cell modules one by one, and there is a problem that accurate measurement is difficult because of a change in performance caused due to an influence of solar radiation and temperature. Accordingly, there is a technique for applying an electric field to a solar cell to image emitted light due to recombination of electrons and holes entering a semiconductor, and analyzing the image (electroluminescence image (EL image)) to inspect the solar cell module.

JP 2013-036747 A below describes a technique for performing measurement using an image when a solar cell is energized. This patent literature describes, as an objective, “to provide an inspection device and an inspection method for a solar cell array calculating an estimated value of reduced output power for a defective solar cell panel” and a technique of “an inspection method for the solar cell array including a plurality of solar cell panels 10, the method including connecting a direct-current power supply 6 to the solar cell array for energization, acquiring an image of the solar cell panel 10 of the solar cell array, analyzing the image and calculating an index, calculating an estimated value of output power of the solar cell panel 10 using output characteristics of the solar cell panel 10 with respect to the index, and determining whether to replace the solar cell panel 10 based on the calculated estimated value” (see ABSTRACT).

### SUMMARY OF THE INVENTION

As a cause of deterioration in the solar cell module, deterioration in shunt resistance is conceivable. The degree of deterioration in the solar cell can be estimated by estimating the deterioration in shunt resistance. However, it has been found from the knowledge of the present inventors that there is a case where it is considered that the performance of a solar cell is likely to deteriorate due to local deterioration in series resistance included in a solar cell among actual deterioration cases of solar cells.

When IV characteristics of a solar cell module are used to detect a local deterioration in shunt resistance, there is a possibility of being affected by solar radiation or temperature. On the other hand, the measurement method of the related art using the EL image as in JP 2013-036747 A does not provide a method of specifically considering an influence of a local deterioration in shunt resistance.

The present invention has been made in view of the above problems, and an objective of the present invention is to provide a technique capable of accurately diagnosing the performance of a solar cell module using an EL image of the solar cell module.

In a quality estimation method according to an aspect of the present invention, a relationship between luminance of an EL image and quality of a solar cell module is learned in advance by a learning device, quality classification of the solar cell module is acquired from an output layer of the learning device, and detailed classification of the quality of the solar cell module is acquired from an intermediate layer of the learning device.

According to the quality estimation method of the present invention, performance of a solar cell module can be accurately diagnosed using an EL image of the solar cell module. Problems, configurations, effects, and the like other than the above will be apparent from the following description of embodiments.

### BRIEF DESCRIPTION OF THE DRAWINGS

FIG. 1A illustrates a configuration of a solar cell panel;

FIG. 1B illustrates a configuration of the solar cell panel;

FIG. 2A is a front view and a back view of a solar cell;

FIG. 2B is an equivalent circuit diagram of a solar cell module;

FIG. 3 is a side sectional view of the solar cell module;

FIG. 4 illustrates an example of ranking quality of the solar cell module;

FIG. 5A illustrates an example of equipment for capturing an EL image of the solar cell module;

FIG. 5B illustrates an example of equipment for capturing an EL image of the solar cell module;

FIG. 6 illustrates an example of a region where an EL image of the solar cell module is captured;

FIG. 7A illustrates an example of luminance of each region of an EL image;

FIG. 7B illustrates an example of data input to a learning device that estimates quality of the solar cell module;

FIG. 8 illustrates a process in which the learning device performs machine learning;

FIG. 9 is a flowchart illustrating a procedure for estimating the quality of the solar cell module using the learning device;

FIG. 10 illustrates a process in which a learning device performs machine learning;

FIG. 11 illustrates a process in which a learning device performs machine learning;

FIG. 12 is a graph illustrating a relationship between a test elapsed-time and a power decrease of a solar cell module when an acceleration test is performed on the solar cell module;

FIG. 13 is a block diagram of a quality estimation device according to a fourth embodiment; and

FIG. 14 illustrates an example of a user interface presenting a result of estimating the quality of the solar cell module using the learning device.

### DESCRIPTION OF THE PREFERRED EMBODIMENTS

### First Embodiment

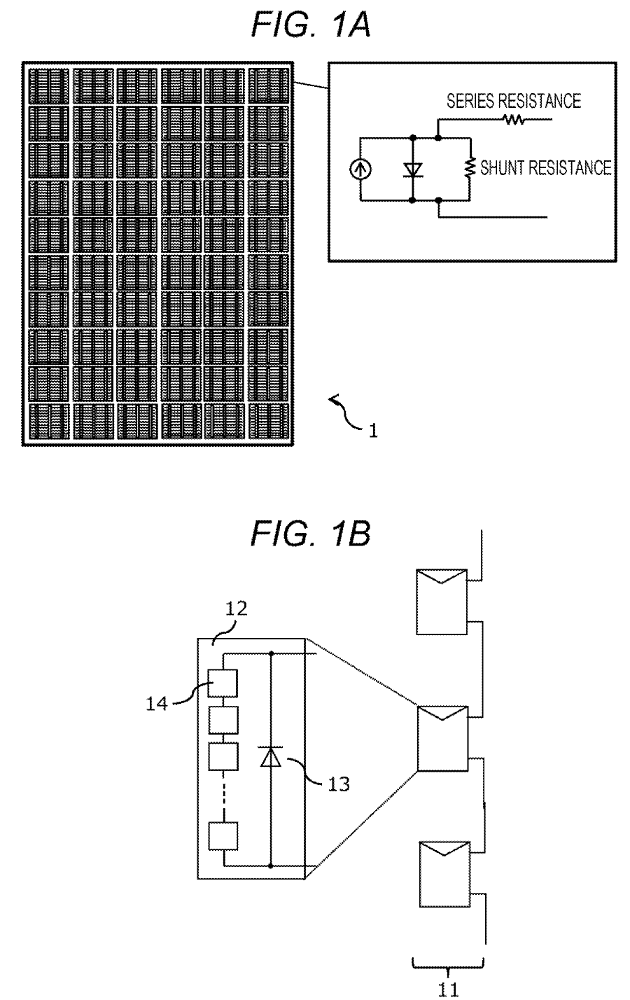

FIGS. 1A and 1B illustrate a configuration of a solar cell panel 1. The solar cell panel 1 is configured by arranging solar cell modules 12. A solar cell string 11 is configured by connecting the solar cell modules 12 in series and bypassing each solar cell 14 by a bypass diode 13. The solar cell module 12 is configured by connecting the solar cells 14 in series. An equivalent circuit of the solar cell 14 has a current source, a pn junction diode, a shunt resistor (parallel resistor), and a series resistor. The current source supplies a current proportional to an amount of solar radiation. When any of the solar cells 14 in the solar cell module 12 fails, the failed solar cell module 12 is bypassed by the bypass diode 13.

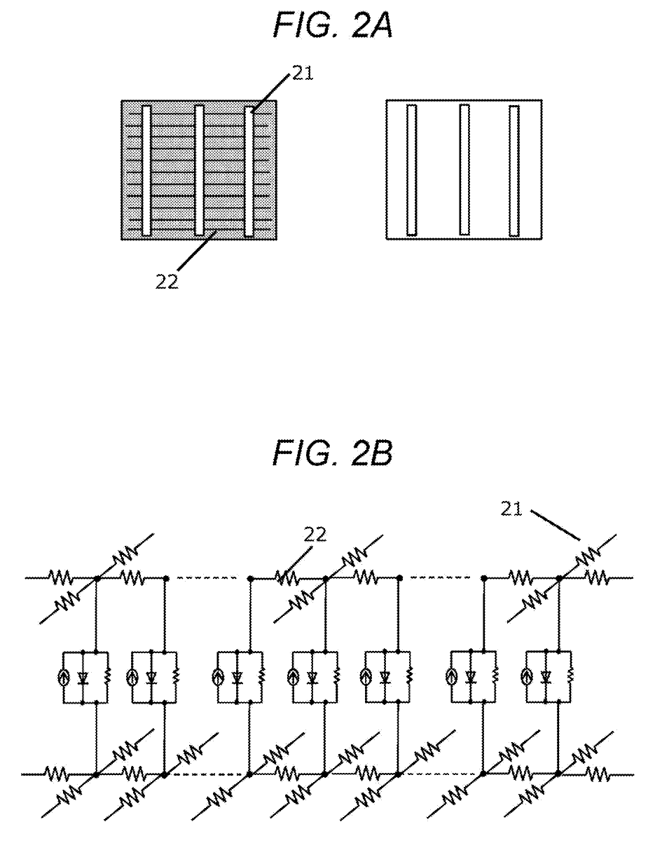

FIG. 2A is a front view and a back view of a solar cell. A bus bar 21 and a finger 22 are arranged on the surface of the solar cell. A back surface resistor is disposed in a planar shape on the back surface of the solar cell.

FIG. 2B is an equivalent circuit diagram of the solar cell module. The finger 22 can be represented as series connection of resistors of solar cells connected in series. The solar cell is disposed between the finger 22 on the surface and the back surface resistor. The bus bar 21 extends in a direction orthogonal to the finger 22 at a contact point between the solar cell and the finger 22.

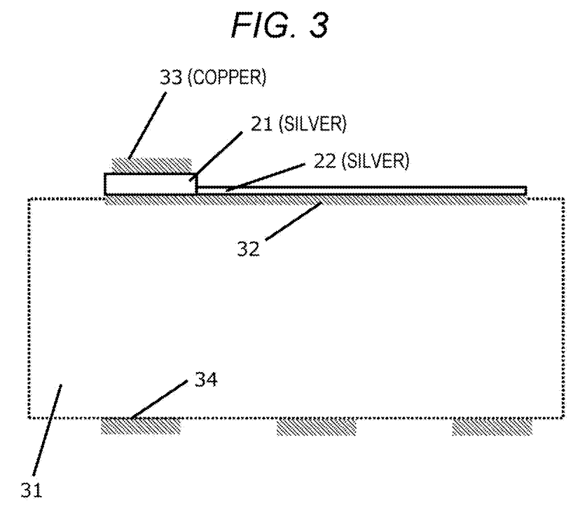

FIG. 3 is a side sectional view of the solar cell module. The bus bar 21 and the finger 22 are mounted on a silicon crystal 31. An adhesive interface 32 is formed between the bus bar 21 and the silicon crystal 31 and between the finger 22 and the silicon crystal 31. An interconnector 33 is disposed on the bus bar 21. A back surface electrode 34 is formed on the back surface of the silicon crystal 31.

In the adhesive interface 32, stress is constantly generated due to a difference between an expansion coefficient of the bus bar 21, an expansion coefficient of the finger 22, and an expansion coefficient of the silicon crystal 31. This may cause local deterioration in the bus bar 21 or the finger 22. When moisture enters between the bus bar 21 and the silicon crystal 31 and between the finger 22 and the silicon crystal 31, an oxide film is generated, which may cause deterioration. Further, when acetic acid is generated due to hydrolysis of a sealing material, this may cause corrosion deterioration of the bus bar 21. Due to these causes, the bus bar 21 or the finger 22 locally increases in resistance and deteriorates, which causes deterioration in quality of the solar cell module.

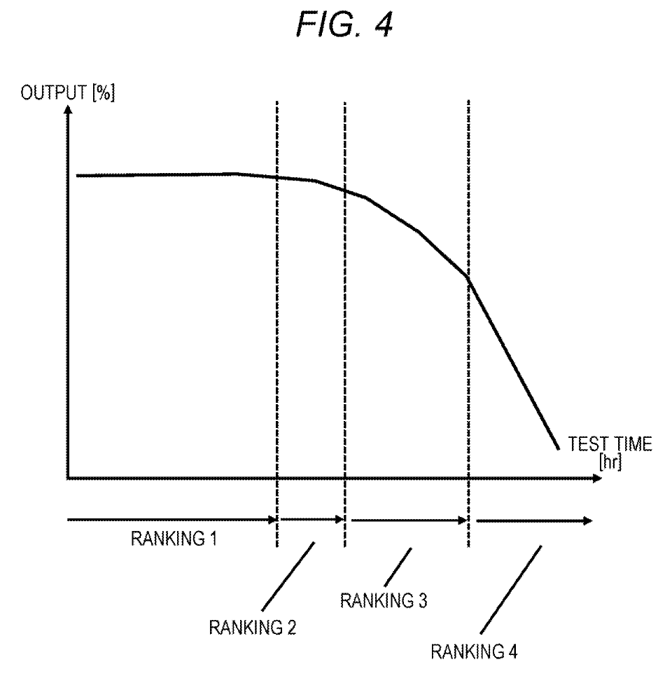

FIG. 4 illustrates an example of ranking quality of the solar cell module. As the quality of the solar cell module deteriorates, a cell output decreases. Here, the quality is divided into four stages, and the quality is assumed to be high in order of ranking 1 to ranking 4. In general, since the quality of the solar cell module deteriorates over time, it can be said that the ranking decreases as the operation time increases. Similarly, when an acceleration test is performed, the ranking decreases as the test elapsed-time increases.

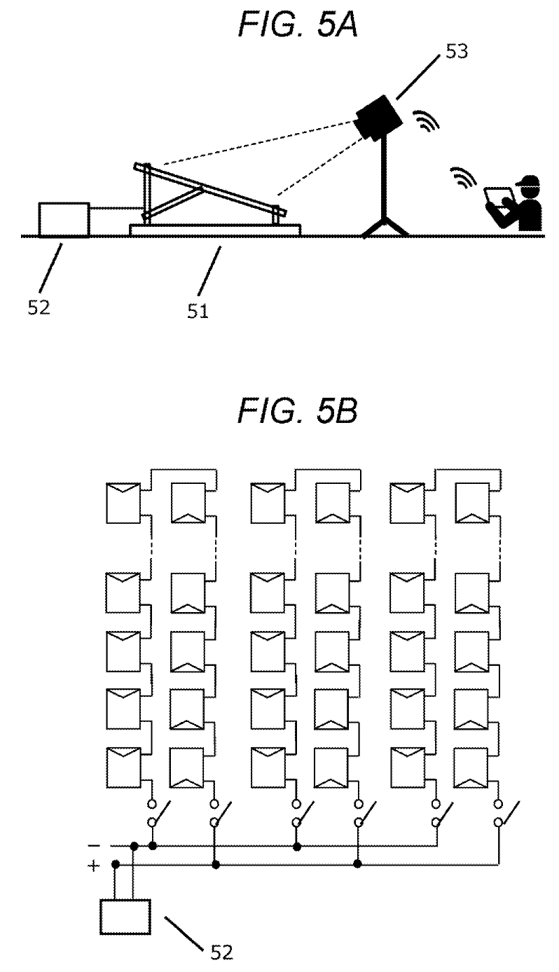

FIGS. 5A and 5B illustrate examples of equipment for capturing an EL image of a solar cell module. A current source 52 is connected to a solar cell array 51, and a current is applied to the solar cell module. Light emission generated by the application of the current is captured by an EL camera 53.

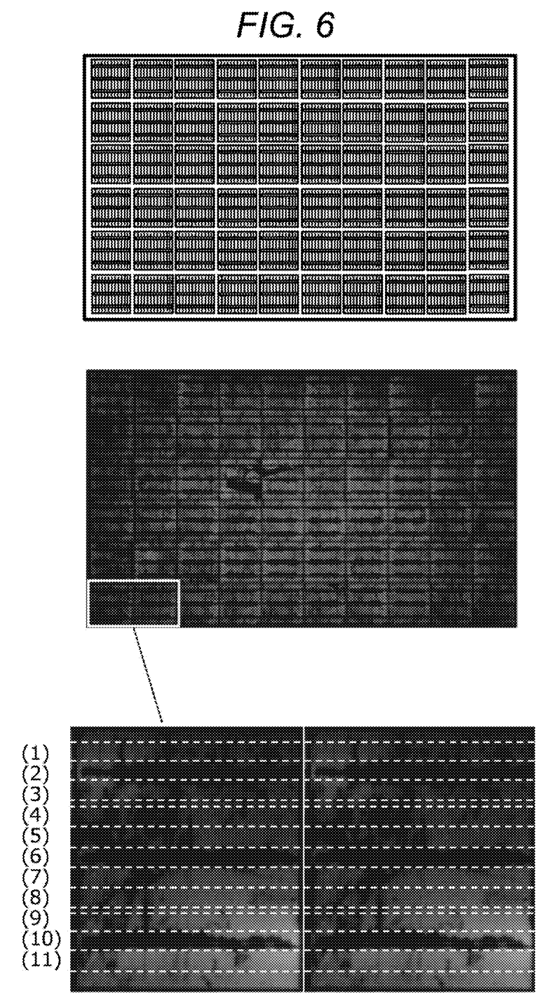

FIG. 6 illustrates an example of a region where an EL image of the solar cell module is captured. In FIG. 6, the bus bar 21 in each solar cell module extends in a lateral direction of the drawing. The surface region of the solar cell module is divided into a region including the bus bar 21 and a region not including the bus bar 21, and an EL image is captured for each region. FIG. 6 illustrates an example in which the surface region of the solar cell module is divided into eleven regions.

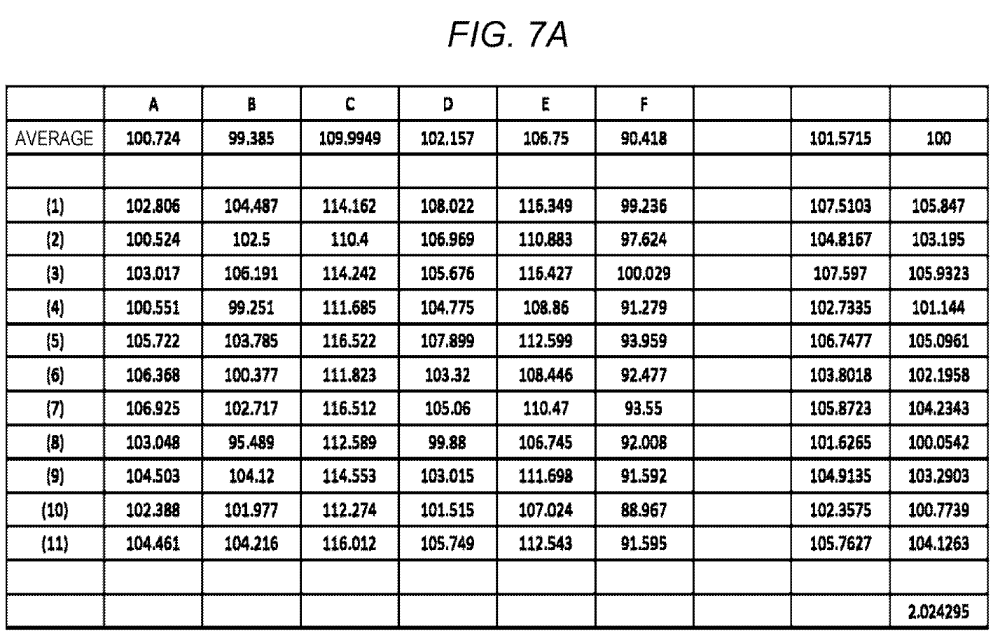

FIG. 7A illustrates an example of luminance of each region of the EL image. Here, an example in which each of the eleven regions illustrated in FIG. 6 includes six solar cells A to F is illustrated. The second row indicates an average of luminance of each column. The second column from the right indicates an average of the luminance of each region. The rightmost column is obtained by normalizing the average of the luminance of each region by 100. The bottom right indicates a standard deviation of the average luminance of each region.

FIG. 7B illustrates an example of data input to a learning device that estimates quality of the solar cell module. Here, an example in which the learning device is configured by a neural network that includes an input layer, an intermediate layer, and an output layer will be described.

An average luminance value of eleven regions in the rightmost column in FIG. 7A is input to the input layer. Further, the standard deviation (or a value obtained by subtracting the standard deviation from the average luminance value, which is the latter in FIG. 7B) in the lower right of FIG. 7A is input to the input layer. The upper left of an input layer matrix in FIG. 7B is the standard deviation. The other eleven cells are average luminance values of the eleven regions. It is additionally noted that numerical values are tentative values (that is, the numerical values do not necessarily match each other in FIGS. 7A to 7B, and the same applies to the neural network shown below).

The reason why the standard deviation (or an equivalent value derived from the standard deviation) is input to the learning device in addition to the average luminance value of the eleven regions is as follows. The standard deviation represents a variation in the average luminance value of each region. The fact that a variation is large suggests that deterioration in the quality of the solar cell module is in progress. This deterioration in quality appears due to an increase in an area of a dark region on the EL image. That is, as the deterioration progresses and the standard deviation increases, (average luminance value-standard deviation) also decreases. By inputting this information to the learning device, it is possible to achieve contribution to quality estimation.

In a learning phase, data is input to the input layer, and correct data is input. For example, two neurons are provided in the output layer. When an output of each neuron is (0, 1), the solar cell module is ranked 1 or 2. When the output is (1, 0), the solar cell module is ranked 3 or 4. The learning device learns a relationship between the correct data and the input data by machine learning.

In the embodiment, as will be described below, distinction between rankings 1 and 2 and distinction between rankings 3 and 4 are identified by an output of the intermediate layer. Accordingly, there are two combinations of pieces of data given as correct data. Here, four combinations of pieces of correct data may be provided so that all rankings 1 to 4 can be identified.

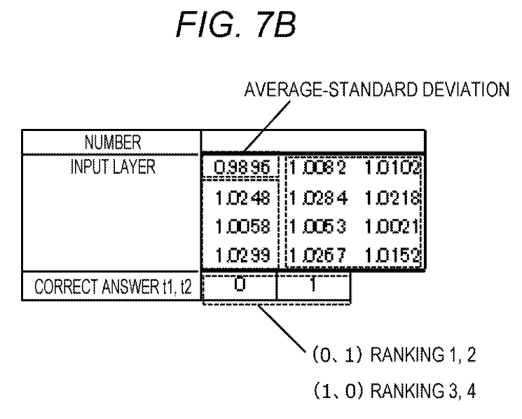

FIG. 8 illustrates a process in which the learning device performs machine learning. For EL images in various deterioration states, the input data and the learning data described in FIGS. 7A to 7B are input repeatedly. Here, nine pairs of pieces of input data and learning data are input from left to right in the drawing. A hidden layer (intermediate layer) includes three neurons. An output of the hidden layer and an output of the output layer are calculated by a calculation formula in the lower part of the drawing. An error is a difference between the correct answer and the output. Machine learning is performed such that the error approaches 0.

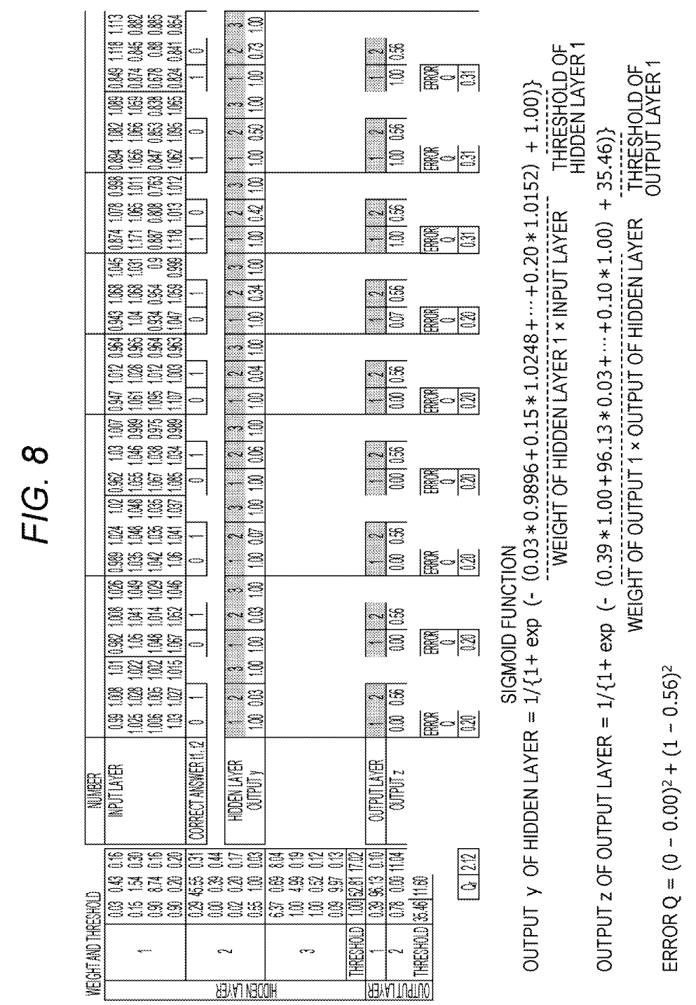

FIG. 9 is a flowchart illustrating a procedure for estimating the quality of the solar cell module using the learning device. This flowchart can be implemented by, for example, the quality estimation device 100 to be described below. First, an EL image of the solar cell module is acquired. The EL image is divided into regions as described with reference to FIG. 6, and normalized luminance and the standard deviation (or a value that can be derived from the standard deviation, for example, average luminance-standard deviation) of each region are calculated. Based on a calculation result, learning data to be input to the learning device (a pair of data to be input to the input layer and correct data) is generated, and machine learning is performed. When the learning is completed, new input data is input to the learning device, and an estimation result is acquired from the output layer.

An example of the estimation result output by the output layer indicates whether the quality of the solar cell module is ranking 1 or 2 or ranking 3 or 4 as illustrated in FIG. 7B. As will be described in embodiments below, an output of the intermediate layer may be further obtained, and the ranking may be further divided in detail using the obtained output.

### Second Embodiment

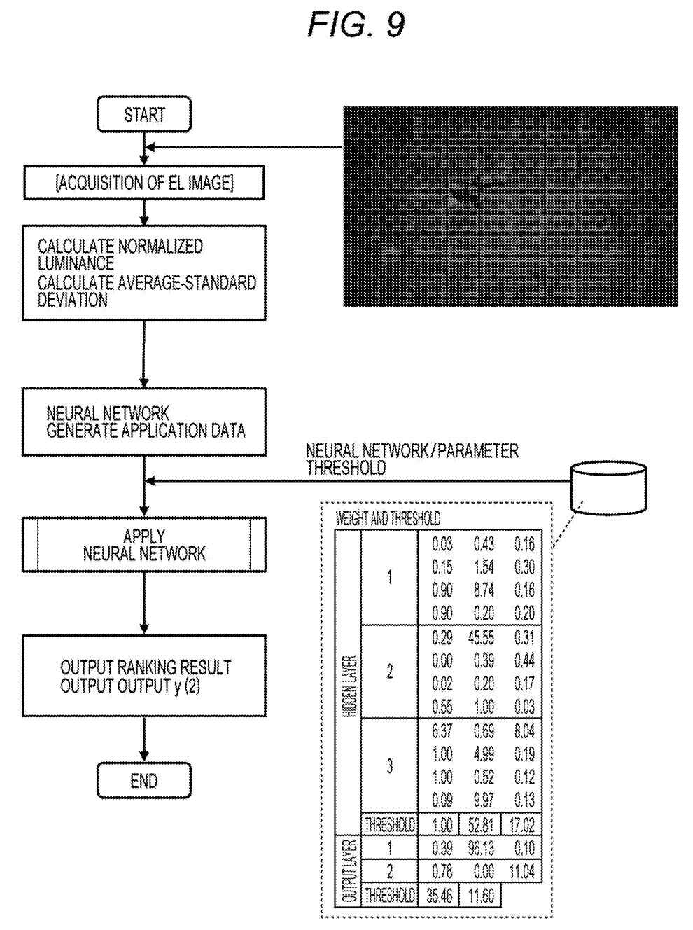

FIG. 10 illustrates a process in which a learning device performs machine learning. In the first embodiment, it has been described that when an output from the two neurons of the output layer is (0, 1), the solar cell module is ranked 1 or 2, and when the output is (1, 0), the solar cell module is ranked 3 or 4. However, depending on the progress of the learning, the neurons of the output layer do not necessarily output 0 or 1, and may output a non-integer value such as (0.01, 0.995). In this case, an estimation result may be determined as follows. Other configurations are similar to those of the first embodiment.

In the learning phase, the correct data is given so that the solar cell module is ranked 1 or 2 when an output of each neuron is (0, 1), and the solar cell module is ranked 3 or 4 when the output is (1, 0), and then the machine learning is advanced. Accordingly, it is considered that the learning device is configured according to the progress of the learning such that a first neuron z(1) of the output layer outputs a smaller value than the second neuron z(2) when the solar cell module is in ranking 1 or 2, and the first neuron z(1) outputs a value equal to or greater than the second neuron z(2) when the solar cell module is in ranking 3 or 4.

Accordingly, when a value other than (0, 1) and (1, 0) is obtained from the output layer and z(1)<z(2), the ranking may be regarded as ranking 1 or 2. When z(1)≥z(2), the ranking may be regarded as ranking 3 or 4. Accordingly, the value of the output layer is not an integer, an estimation result can be obtained.

### Third Embodiment

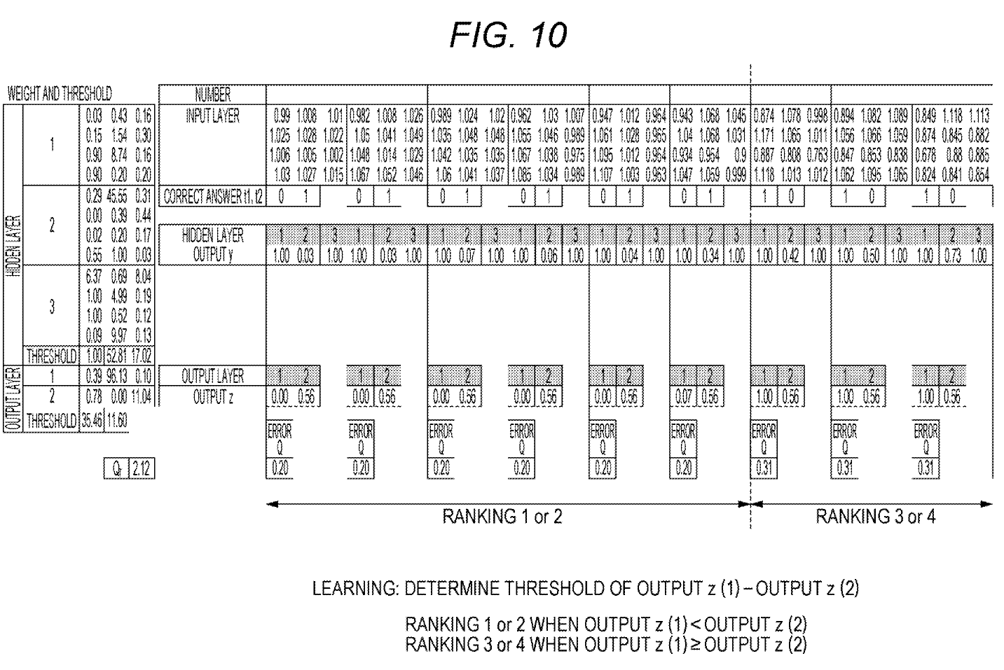

FIG. 11 illustrates a process in which a learning device performs machine learning. In the second embodiment, it has been described that one of ranking 1 or 2 and ranking 3 or 4 is determined according to a larger value between the two neurons z(1) and z(2) of the output layer. In addition, ranking estimation results may be classified in more detail using an output of the intermediate layer. In a third embodiment of the present invention, a configuration example thereof will be described. Other configurations are similar to those of the first embodiment.

The learning device illustrated in FIG. 11 includes three neurons in a hidden layer (intermediate layer). The learning phase is advanced such that an output value of any one (a second y(2) in the example of FIG. 11) of the neurons represents detailed classification of the ranking. For example, when the output layer indicates that the quality of the solar cell module is ranking 1 or 2, the learning phase is advanced so that the solar cell module is ranked 1 if y(2) is less than a first threshold (0.3 in this example), and the solar cell module is ranked 2 if y(2) is the first threshold or more. Similarly, when the output layer indicates that the quality of the solar cell module is ranking 3 or 4, the learning phase is advanced so that the solar cell module is ranking 3 if y(2) is less than a second threshold (0.5 in this example), and the solar cell module is ranking 4 if y(2) is the second threshold or more.

When an estimation result is acquired, input data is input to the input layer to obtain an output from the output layer. According to whether the output from the output layer represents ranking 1 or 2 or ranking 3 or 4, more detailed ranking classification is acquired based on the value of y(2) described above. Accordingly, it is possible to obtain detailed classification of the quality of the solar cell module.

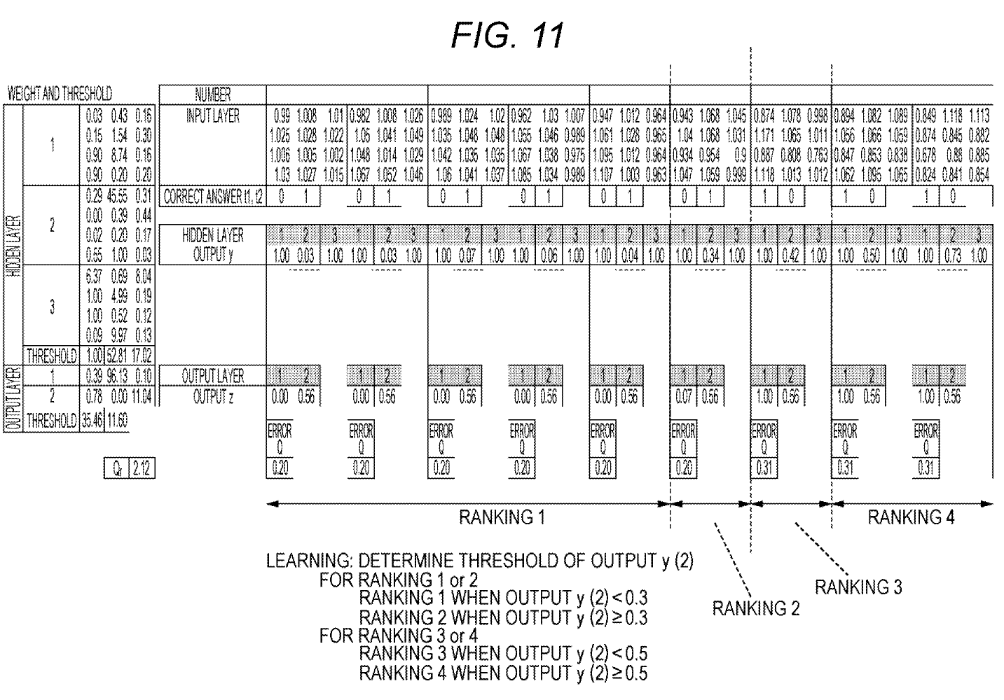

FIG. 12 is a graph illustrating a relationship between a test elapsed-time and a power decrease of a solar cell module when an acceleration test is performed on the solar cell module. When the acceleration test is performed, deterioration in the solar cell module progresses according to the test elapsed-time, and thus an output gradually decreases. This means that quality ranking of the solar cell module gradually decreases from ranking 1 to ranking 4. Accordingly, when the quality ranking is acquired from the learning device, it is possible to estimate how much the quality of the solar cell module corresponds to the elapsed-time in the acceleration test based on the value of the intermediate layer y(2). In the example of FIG. 11, the value of y(2) represents the quality ranking. This is considered to correspond to the elapsed-time in the acceleration test.

It is considered that the elapsed-time in the acceleration test increases as the value of y(2) increases. Therefore, the relationship between the elapsed-time and the value may be measured in advance, and the elapsed-time in the acceleration test may be estimated from the value of y(2) according to this relationship. Data describing this relationship may be prepared in advance outside of the learning device.

### Fourth Embodiment

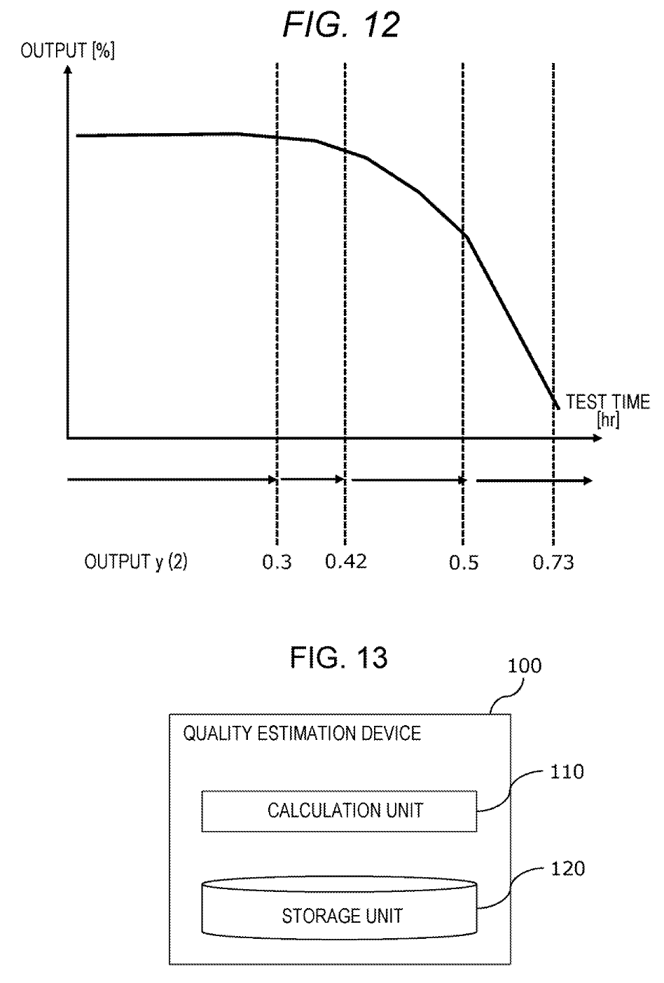

FIG. 13 is a block diagram of a quality estimation device 100 according to a fourth embodiment of the present invention. The quality estimation device 100 is a device that estimates quality of a solar cell module. The quality estimation device 100 includes a calculation unit 110 and a storage unit 120. The calculation unit 110 performs the procedure described in the above embodiment. The storage unit 120 stores data used by the calculation unit 110. For example, internal parameters of the learning device described in the above embodiment can be stored. The calculation unit 110 implements the learning device using the internal parameters and estimates the quality of the solar cell module by performing the procedure described in the above embodiment.

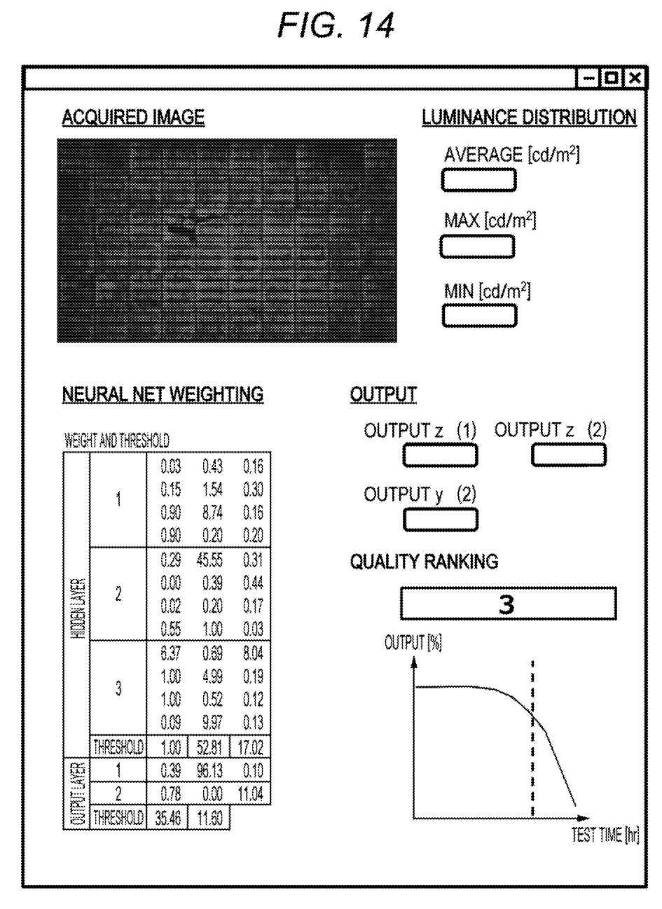

FIG. 14 illustrates an example of a user interface that presents a result of estimating the quality of the solar cell module using the learning device. This user interface can be presented by the quality estimation device 100 (calculation unit 110). This user interface can present, for example: (1) an EL image of the solar cell module; (2) luminance of the EL image or statistical values of the luminance (example: average luminance, maximum luminance, or minimum luminance); (3) internal parameters such as a weight value and a threshold in each layer of a neural network included in the learning device; (4) an output from each layer of the learning device; (5) a result obtained by the learning device estimating the quality (ranking) of the solar cell module, and (6) a relationship between the test time and the output illustrated in FIG. 12.

### Modifications of Present Invention

The present invention is not limited to the above-described embodiments, and includes various modifications. For example, the above-described embodiments have been described in detail for easy understanding of the present invention, and are not necessarily limited to those having all the described configurations. Some of the configurations of a certain embodiment can be replaced with configurations of another embodiment. To the configurations of a certain embodiment, configurations of another embodiment can be added. It is possible to add, delete, and replace other configurations to, from, and with some of the configurations of each embodiment.

In the above embodiment, the calculation unit 110 can be configured with hardware such as a circuit device on which the function is implemented, or can be configured by executing software on which the function is implemented by a calculation device such as a central processing unit (CPU).

In the above embodiment, it has been described that the EL image is divided into the region including the bus bar 21 and the region not including the bus bar 21. Alternatively or additionally, the EL image may be divided into a region including the finger 22 and a region not including the finger 22. However, when the local deterioration of the solar cell module is mainly caused by the bus bar 21, it is considered desirable to divide the EL image into a region including the bus bar 21 and a region not including the bus bar 21 in principle, and to preliminarily use the finger 22.

What is claimed is:

1. A quality estimation method of estimating quality of a solar cell module, the method comprising:
acquiring an image obtained by capturing light emission generated by recombination of electrons and holes of a pn junction included in the solar cell module;
dividing the image into a plurality of regions and calculating luminance of each of the regions; and
acquiring a result of estimating the quality of the solar cell module from a learning device by inputting the calculated luminance to the learning device that has learned a relationship between the luminance of each of the regions and the quality of the solar cell module by machine learning,
wherein
the learning device includes an input layer, an intermediate layer, and an output layer,
the learning device performs the machine learning in advance to classify the quality of the solar cell module in accordance with an output from the output layer,
the learning device performs the machine learning in advance to more finely classify the quality based on the output from the output layer in accordance with an output from the intermediate layer, and
in the acquiring of the quality, the classification of the quality of the solar cell module based on at least the output from the output layer is acquired by inputting the calculated luminance to the learning device.

2. The quality estimation method according to claim 1, wherein
the solar cell module includes a bus bar electrode and a finger electrode extending in a direction not parallel to the bus bar electrode, and
in the calculating of the luminance, the image is divided into the region including the bus bar electrode and the region not including the bus bar electrode.

3. The quality estimation method according to claim 1, wherein
in the calculating of the luminance, a normalized luminance obtained by normalizing the luminance of each of the regions is calculated, and
in the acquiring of the quality, the normalized luminance is input as the calculated luminance to the learning device.

4. The quality estimation method according to claim 1, wherein
the input layer is configured to receive:
luminance of each of the regions, and
a numerical value indicating a variation in luminance of each of the regions as an input,
the learning device learns a relationship between the luminance of each of the regions, the variation, and the quality in advance by the machine learning,
in the calculating of the luminance, a numerical value representing the variation in luminance of each of the regions is calculated, and
in the acquiring of the quality, the classification of the quality of the solar cell module is acquired by inputting the calculated luminance and the calculated variation to the learning device.

5. The quality estimation method according to claim 1, wherein
the output layer is configured to output a plurality of output values,
the learning device performs the machine learning in advance to classify the quality of the solar cell module in accordance with a magnitude relationship of the plurality of output values, and
in the acquiring of the quality, the classification of the quality of the solar cell module is acquired by comparing the plurality of output values from the output layer.

6. The quality estimation method according to claim 1, wherein
the learning device performs the machine learning in advance to more finely classify the quality that is based on the output from the output layer in accordance with whether the output from the intermediate layer is equal to or greater than a threshold, and
in the acquiring of the quality, the classification of the quality of the solar cell module is acquired by comparing the output from the intermediate layer with the threshold.

7. The quality estimation method according to claim 1, wherein
the learning device learns in advance, by the machine learning, a relationship among the output of the intermediate layer, an elapsed-time when an acceleration test is performed on the solar cell module, and performance deterioration in the solar cell module due to the acceleration test, and
in the acquiring of the quality, which elapsed-time in the acceleration test corresponds to the performance deterioration of the solar cell module is acquired based on the output from the intermediate layer.

8. The quality estimation method according to claim 1, wherein
in the acquiring of the image, the light emission is caused by applying a current to the solar cell module.

9. The quality estimation method according to claim 1, wherein
the solar cell module includes a bus bar electrode and a finger electrode extending in a direction not parallel to the bus bar electrode, and
a temporal change in luminance of each of the regions is caused by performance deterioration due to a local resistance increase of at least one of the bus bar electrode and the finger electrode.

10. A quality estimation device estimating quality of a solar cell module, the device comprising:
a calculation unit configured to estimate the quality,
wherein
the calculation unit performs:
acquiring an image obtained by capturing light emission generated by recombination of electrons and holes of a pn junction included in the solar cell module,
dividing the image into a plurality of regions and calculating luminance of each of the regions, and
acquiring a result of estimating the quality of the solar cell module from a learning device by inputting the calculated luminance to the learning device that has learned a relationship between the luminance of each of the regions and the quality of the solar cell module by machine learning,
the learning device includes an input layer, an intermediate layer, and an output layer,
the learning device performs the machine learning in advance to classify the quality of the solar cell module in accordance with an output from the output layer,
the learning device performs the machine learning in advance to more finely classify the quality based on the output from the output layer in accordance with an output from the intermediate layer, and
in the acquiring of the quality, the classification of the quality of the solar cell module based on at least the output from the output layer is acquired by inputting the calculated luminance to the learning device.
